(19) United States
(12) Patent Application Publication
(10) Pub. No.: US 2007/0288455 A1
(43) Pub. Date: Dec. 13, 2007

(54) Method of optimizing Web hyperlink text for better listed search result

(75) Inventor: Chung-Hung Hsu, Taichung City (TW)

Correspondence Address: BACON & THOMAS, PLLC, 625 SLATERS LANE, FOURTH FLOOR, ALEXANDRIA, VA, 22314, US

(73) Assignee: GU TA INTERNET INFORMATION CO., LTD., TAICHUNG CITY (TW)

(21) Appl. No.: 11/650,930

(22) Filed: Jan. 9, 2007

(30) Foreign Application Priority Data
Jun. 8, 2006 (TW) 95120462

(51) Int. Cl. G06F 17/30

(52) U.S. Cl. 707/5

(57) ABSTRACT

A method of optimizing a web hyperlink text for a better listed search result includes steps of partitioning the hyperlink text into four parts defined as a first part, a second part, a third part, and a fourth part, wherein each of the first and fourth parts has at least one of a product name, a product category, and a product manufacture, the second part is a domain name, and the third part is a country/region name; and placing a preposition “on” between the first and second parts and placing another preposition “from” between the second and third parts, whereby the hyperlink text is arranged like “[first part] [on] [second part] [from] [third part] [fourth part]”. In light of this, the web hyperlink text can preferably match the rules set in the search engine to be ranked high in the listed search result.

### BACKGROUND OF THE INVENTION

1. Field of the Invention

The present invention relates generally to search technology on Internet, and more particularly, to a method of optimizing a web hyperlink text for a better listed search result.

2. Description of the Related Art

A conventional web hyperlink text is designed generally by a descriptive text set as a hyperlink to allow the internet visitor to identify the content to which the descriptive text is linked by reading the descriptive text and then to determine whether the hyperlink should be clicked. Among the currently available web page searching techniques, there is one which analyzes the web hyperlink text for further search outcome. While searching on Internet through such technique, a search keyword is inputted for comparison with the web hyperlink texts to source the visitor's desired web pages.

In addition, the owner of web pages, particularly the commercial ones, generally hopes that more people visit the web pages to enhance the trading opportunities or flows to further increase trading or advertising income. Therefore, the owner of the web pages would like to do the best to enable the web pages to match the conditions set in the search engine to further enable the web hyperlink text to be ranked first or high in the listed search result.

### SUMMARY OF THE INVENTION

The primary objective of the present invention is to provide a method of optimizing a web hyperlink text for a better listed search result, which enables the web hyperlink text to be ranked high in a listed search result after searched by a search engine.

The foregoing objective of the present invention is attained by the method including steps of partitioning a hyperlink text into four parts defined as a first part, a second part, a third part, and a fourth part, wherein each of the first and fourth parts has at least one of a product name, a product category, and a product manufacture, the second part is a domain name, and the third part is a country/region name; and placing a preposition “on” between the first and second parts and placing another preposition “from” between the second and third parts, whereby the hyperlink text is arranged like “[first part] [on] [second part] [from] [third part] [fourth part]”. In light of this, the web hyperlink text can preferably match the rules set in the search engine to be ranked high in the listed search result.

### BRIEF DESCRIPTION OF THE DRAWINGS

FIG. 1 is a schematic view of a preferred embodiment of the present invention, illustrating the arrangement of the web hyperlink text.

FIG. 2 is an exemplificative view of the preferred embodiment of the present invention, illustrating the arrangement of the web hyperlink text.

FIG. 3 is an alternative exemplificative view of the preferred embodiment of the present invention, illustrating the arrangement of the web hyperlink text.

### DETAILED DESCRIPTION OF PREFERRED EMBODIMENTS

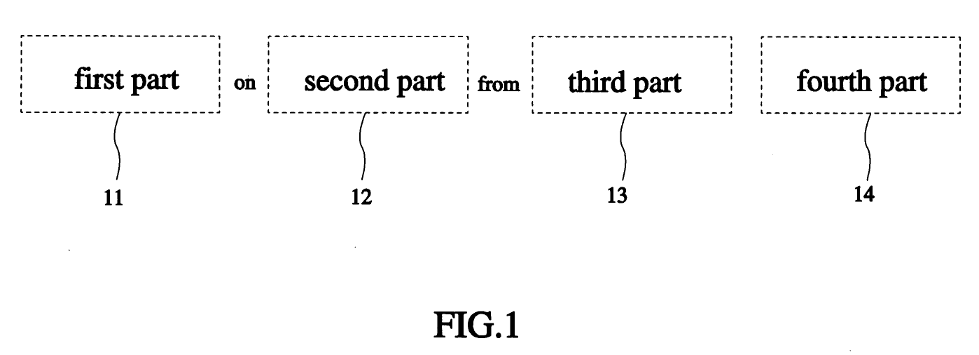

Referring to FIG. 1, a method of optimizing a web hyperlink text for a better listed search result, according to a preferred embodiment of the present invention, includes the following steps.
A. Partition a web hyperlink text 10 into four parts defined as a first part 11, a second part 12, a third part 13, and a fourth part 14. The first and fourth parts 11 and 14 each are a product name/category/manufacture, each having at least one of a product name, a product category, and a product manufacture. The second part 12 is a domain name. The third part 13 is a country/region name, having at least one country/region name.
B. Place a preposition “on” between the first and second parts 11 and 12 and place another preposition “from” between the second and third parts 12 and 13, whereby the hyperlink text is arranged like “[first part] [on] [second part] [from] [third part] [fourth part]”.

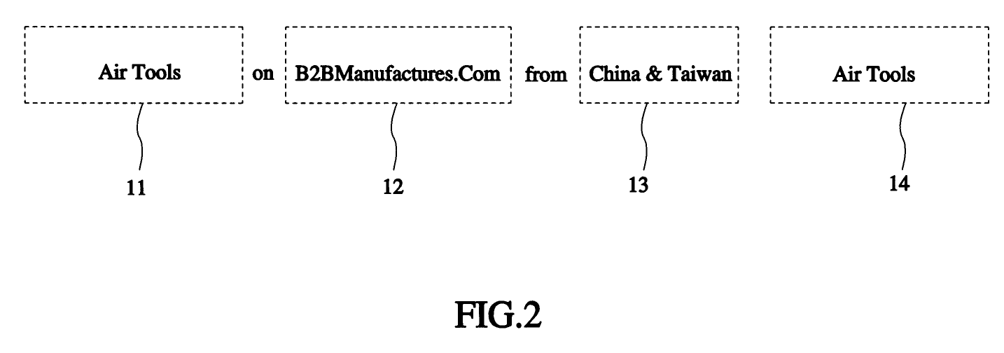

For example, the web hyperlink text 10 is arranged as shown in FIG. 2. The first and fourth parts 11 and 14 each are replaced by a product category “Air Tools”. The second part 12 is replaced by a domain name “B2BManufactures.Com”. The third part 13 is replaced by two country/region names “China & Taiwan”. Thus, the web hyperlink text 10 becomes “Air Tools on B2BManufactures.Com from China & Taiwan Air Tools”. While keywords “Air Tools” are inputted in the Google™ or Yahoo!® search engine for searching relevant web pages, the web page having the web hyperlink text 10, i.e. “Air Tools on B2BManufactures.Com from China & Taiwan Air Tools”, is ranked higher than other web pages having common hyperlink texts in the listed search result.

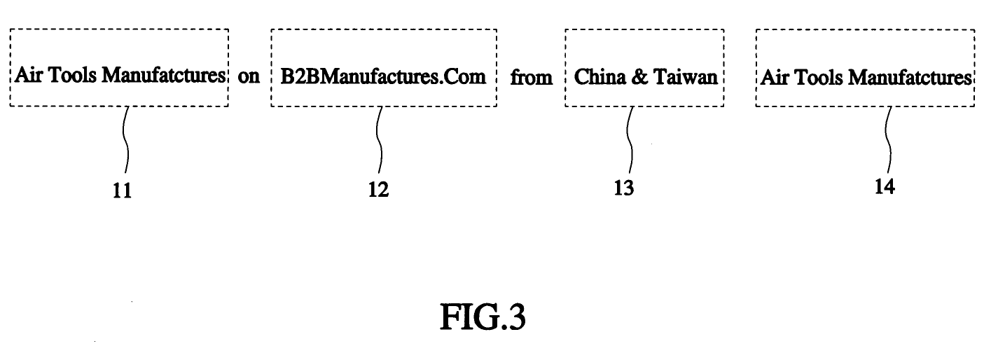

It is to be noted that the product category “Air Tools” replacing each of the first and fourth parts is an example and can be alternative one, like “Tape Dispenser” or “Ball Valve”. If the first and fourth parts 11 and 14 are related to the product manufacture, each of them can be replaced by “Air Tools Maker”, “Air Tools Supplier”, “Air Tools Assembly”, or “Air Tools Manufacturers” as an example. FIG. 3 illustrates the web hyperlink text 10 composed of the first and fourth parts 11 and 14, each of which is replaced by “Air Tools Manufacturers”.

As indicated above, the present invention includes the following advantages. The present invention enables the web hyperlink text to preferably match the rules set in the search engine and to be ranked high in the listed search result after searched by the search engine

Although the present invention has been described with respect to a specific preferred embodiment thereof, it is no way limited to the details of the illustrated product names/categories/manufactures, domain names, and country/region names but changes and modifications may be made within the scope of the appended claims.

What is claimed is:

1. A method of optimizing a web hyperlink text for a better listed search result, comprising steps of:
partitioning said hyperlink text into four parts defined as a first part, a second part, a third part, and a fourth part, wherein each of said first and fourth parts is a product name/category/manufacture, said second part is a domain name, and said third part is a country/region name; and
placing a preposition “on” between said first and second parts and placing another preposition “from” between said second and third parts, whereby said web hyperlink text is arranged like “[first part] [on] [second part] [from] [third part] [fourth part]”.

2. The method as defined in claim 1, wherein said first and fourth parts each comprise at least one of a product name, a product category, and a product manufacturer.

3. The method as defined in claim 1, wherein said third part comprises at least one country/region name.
